(19) United States
(12) Patent Application Publication
(10) Pub. No.: US 2014/0164117 A1
(43) Pub. Date: Jun. 12, 2014

(54) Apparatus and Method for Branded Messaging

(71) Applicant: Karmies LLC, Denver, CO (US)

(72) Inventor: Megan Haines, Denver, CO (US)

(73) Assignee: KARMIES LLC, Denver, CO (US)

(21) Appl. No.: 14/181,511

(22) Filed: Feb. 14, 2014

Related U.S. Application Data
(63) Continuation-in-part of application No. 13/923,127, filed on Jun. 20, 2013.
(60) Provisional application No. 61/662,024, filed on Jun. 20, 2012.

(51) Int. Cl. G06Q 30/02

(52) U.S. Cl. CPC G06Q 30/0257
USPC 705/14.55

(57) ABSTRACT

A method includes prompting a message sender for content options associated with a designated graphical element. A selected content option is received from the message sender. The designated graphical element is associated with the selected content option. A message with the designated graphical element is sent from the message sender to a message receiver. The message receiver is supplied with the selected content in response to activation of the graphical element by the message receiver.

### CROSS-REFERENCE TO RELATED APPLICATIONS

This application is a continuation-in-part of U.S. patent application Ser. No. 13/923,127, filed Jun. 20, 2013.

### FIELD OF THE INVENTION

This invention relates generally to communicating in an electronic network. More particularly, this invention relates to techniques for branded messaging.

### BACKGROUND OF THE INVENTION

Personal communications increasingly transpire through messages in electronic networks, such as Short Message Service (SMS) text messages and email messages. The brevity and lack of tone in such messages have given rise to the use of emoticons. An emoticon is a pictorial representation of a facial expression that allows a message recipient to evaluate the tenor of a message sender's verbal communication. Punctuation marks, numbers and letters may be used to form an emoticon. Alternately, an emoticon may be in the form of a graphical element.

While emoticon use has grown, emoticon usefulness has not. Therefore, it would be desirable to improve the usefulness of emoticons in electronic message personal communications.

### SUMMARY OF THE INVENTION

A method includes prompting a message sender for content options associated with a designated graphical element. A selected content option is received from the message sender. The designated graphical element is associated with the selected content option. A message with the designated graphical element is sent from the message sender to a message receiver. The message receiver is supplied with the selected content in response to activation of the graphical element by the message receiver.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrate processing operations performed in accordance with an embodiment of the invention.

FIG. 3 illustrates a message formed in accordance with an embodiment of the invention.

FIG. 4 illustrates a toggling branded element formed in accordance with an embodiment of the invention.

FIG. 5 illustrates an embedded branded element formed in accordance with an embodiment of the invention.

FIG. 6 illustrates branded content supplied in accordance with an embodiment of the invention.

FIG. 7 illustrates processing operations associated with an alternate embodiment of the invention.

FIGS. 8-14 illustrate exemplary screen shots associated with the processing of FIG. 7.

Like reference numerals refer to corresponding parts throughout the several views of the drawings.

### DETAILED DESCRIPTION OF THE INVENTION

The invention extends the utility of an emoticon by making it a branded element with an associated hyperlink. The brand may be a commercial brand or a brand associated with a social cause. Interaction with the branded element invokes the hyperlink, which results in the retrieval of branded content, as demonstrated below.

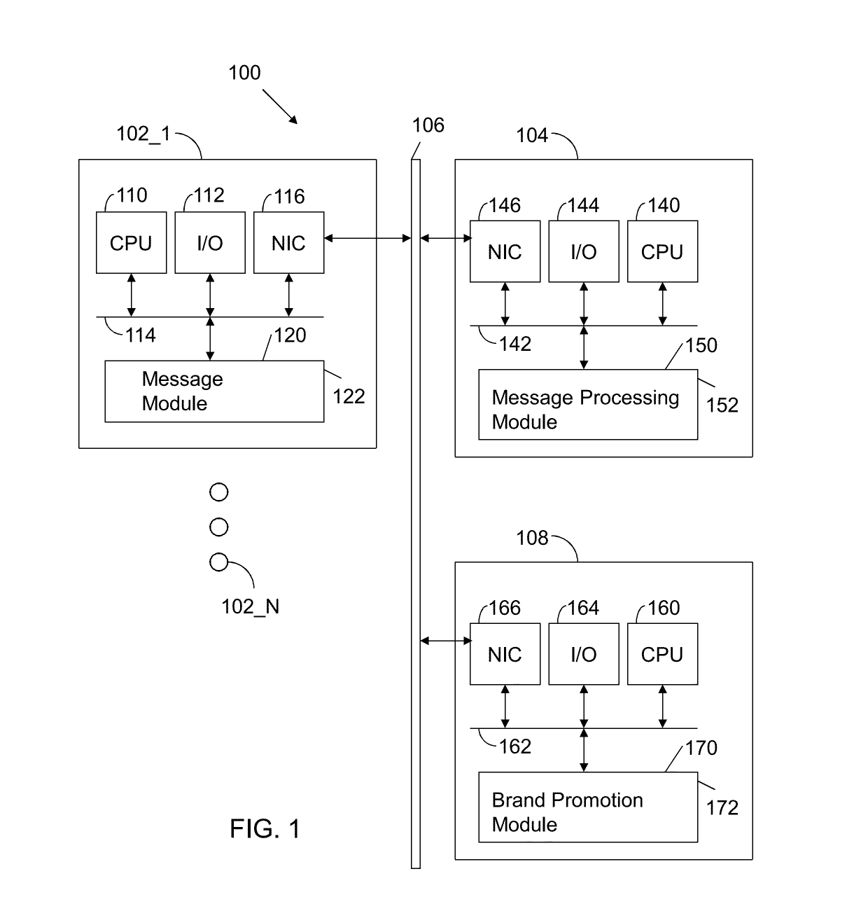

FIG. 1 illustrates a system 100 configured in accordance with an embodiment of the invention. The system 100 includes a set of client devices 102_1 through 102_N. Each client device 102 communicates with a message processing server 104 via a network 106, which may be any wired and/or wireless network. A brand promotion server 108 is also connected to the network 106.

A client device 102 includes standard components, such as a central processing unit 110 and input/output devices 112 connected via a bus 114. The input/output devices 112 may include a keyboard, mouse, touch display and the like. A network interface circuit 116 is also connected to the bus 114 to provide connectivity to network 106. A memory 120 is also connected to the bus 114. The memory stores a message module 122. The message module 122 includes executable instructions to support messaging, such as SMS text messaging and/or email messaging.

Message processing server 104 also includes standard components, such as a central processing unit 140, input/output devices 144 and a network interface circuit 146 connected via a bus 142. A memory 150 is also connected to the bus 142. The memory 150 stores a message processing module 152. The message processing module 152 coordinates electronic messaging, such as SMS text messaging and/or email messaging. The message processing module 152 also logs activity associated with a branded element (e.g., amount of use, remuneration to user for use of a branded element, remuneration to a charity for use of a branded element, etc.).

The brand promotion server 108 also includes standard components, such as a central processing unit 160, a bus 162, input/output devices 164 and a network interface circuit 166. A memory 170 is also connected to the bus 162. The memory stores a brand promotion module 172. The brand promotion module includes executable instructions to supply branded content in response to activation of a hyperlink associated with a branded element. Examples of branded content are provided below. The brand promotion server 108 may be operated by a vendor promoting goods or services. Alternately, the brand promotion server 108 may be combined with the message processing server 104. Any number of network configurations may be used in accordance with embodiments of the invention.

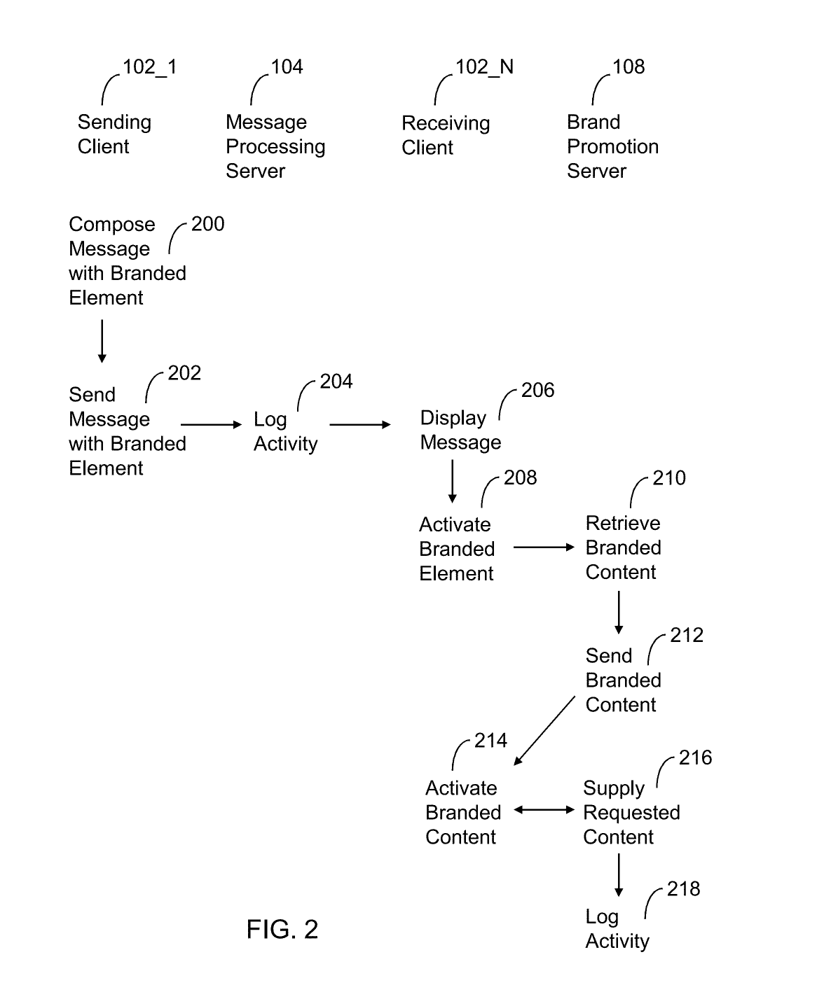

FIG. 2 illustrates processing operations associated with an embodiment of the invention. The figure illustrates different components from FIG. 1 and the operations that they perform in connection with one another. For example, a sending client 102_1 may be operated by a user to compose a message with a branded element 200.

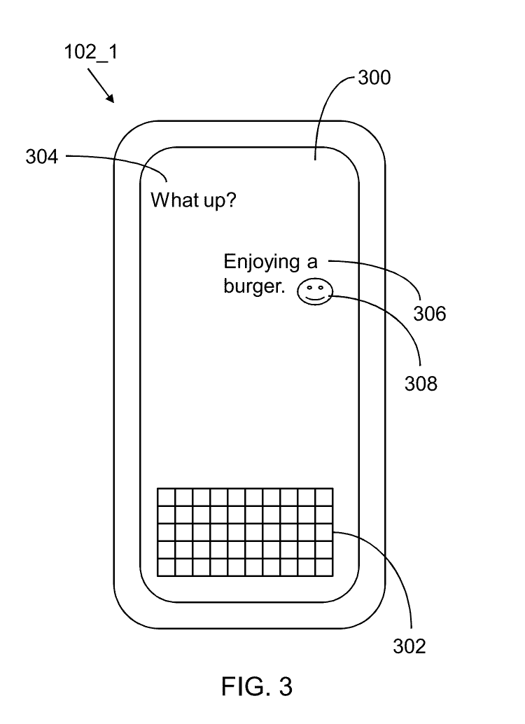

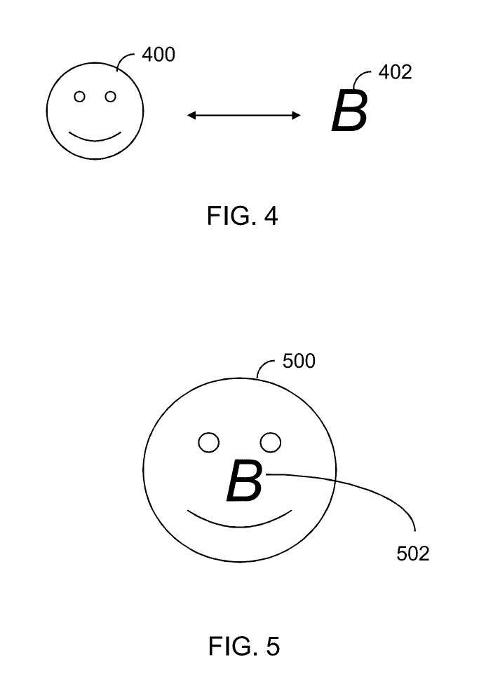

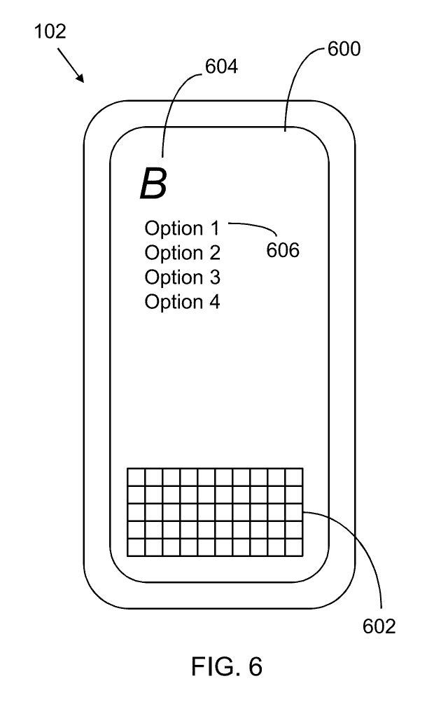

FIG. 3 illustrates an exemplary message sequence. In particular, FIG. 3 illustrates the sending device 102_1 in the form of a Smartphone 300 with a keyboard 302. An initial message 304 is sent. This results in a reply 306, which includes a branded element 308. The branded element is typically an emoticon or graphical element with an associated brand. For example, FIG. 4 illustrates an emoticon 400 which toggles to a brand 402 on an intermittent basis (e.g., every second). Alternately, the branded element may be an emoticon or graphical element 500, as shown in FIG. 5, with an embedded brand 502. Another embodiment of the invention may simply utilize a brand symbol. The branded element may be selected from the keyboard 302. For example, the message module 122 may be a client application which includes a keyboard with various selectable branded elements.

Returning to FIG. 2, the message with the branded element is sent 202. The message processing server 104 logs the message activity 204. For example, the message processing server 104 in the process of routing the message may note the utilization of the branded element and increment a counter. The message processing server 104 may also maintain various rules associated with the utilization of the branded element. For example, the utilization of the branded element by a user may result in some form of remuneration to the user for promoting the brand. The remuneration may go directly to the user. Alternately, the remuneration may be in the form of a donation to a charity specified by the brand and/or the user.

The message is displayed 206 at a receiving client machine 102_N. If the user at the receiving client machine activates the branded element (e.g., by clicking or tapping on it), the hyperlink associated with the branded element is invoked. This may launch a browser, which contacts the brand promotion server 108. The brand promotion server 108 retrieves branded content 210. The branded content is then sent 212 to the receiving client 102-N.

FIG. 4 provides an example of branded content received on the display 600 of a client device 102. The display 600 includes a keyboard 602. In this example, the branded content includes a brand indicator 604 and a set of processing options 606. By way of example, the processing options may include a map from the user's current location to the location of the nearest vendor associated with the branded element. The processing options may include a request for a coupon from the vendor associated with the branded element. The processing options may also include a request for shopping information from the vendor (e.g., a catalog). The processing options may also include a request for a donation to a charity associated specified by the vendor. The request may specify that the donation be made by the vendor and/or the user.

Returning to FIG. 2, activation of the branded content 214 results in the supply of requested content 216. For example, the activation of a map request option results in the supply of a map. The interactions with the client devices are logged 218 by the brand promotion server 108. This allows the brand promotion server to track promotional activity and therefore improve brand promotion operations.

Thus, the invention provides a mechanism for an individual to promote an individual brand to a friend. Such a form of promotion is more powerful than general promotional activity typically undertaken by a vendor. The user may be motivated to promote a brand through some type of remuneration, such as direct remuneration to the user or remuneration in the form of a donation to a charity specified by the vendor and/or the user. In this way, a new promotion scheme is achieved, which benefits both consumers and vendors.

The message processing server 104 may be implemented as a social network platform. For example, the disclosed branded element may accompany a wall post on Facebook® or may accompany a Tweet on Twitter®. The branded element may alternately be implemented as an interactive element without an associated brand. That is, a simple emoticon, sticker or graphical image may be associated with a hyperlink to support interactive delivery of information.

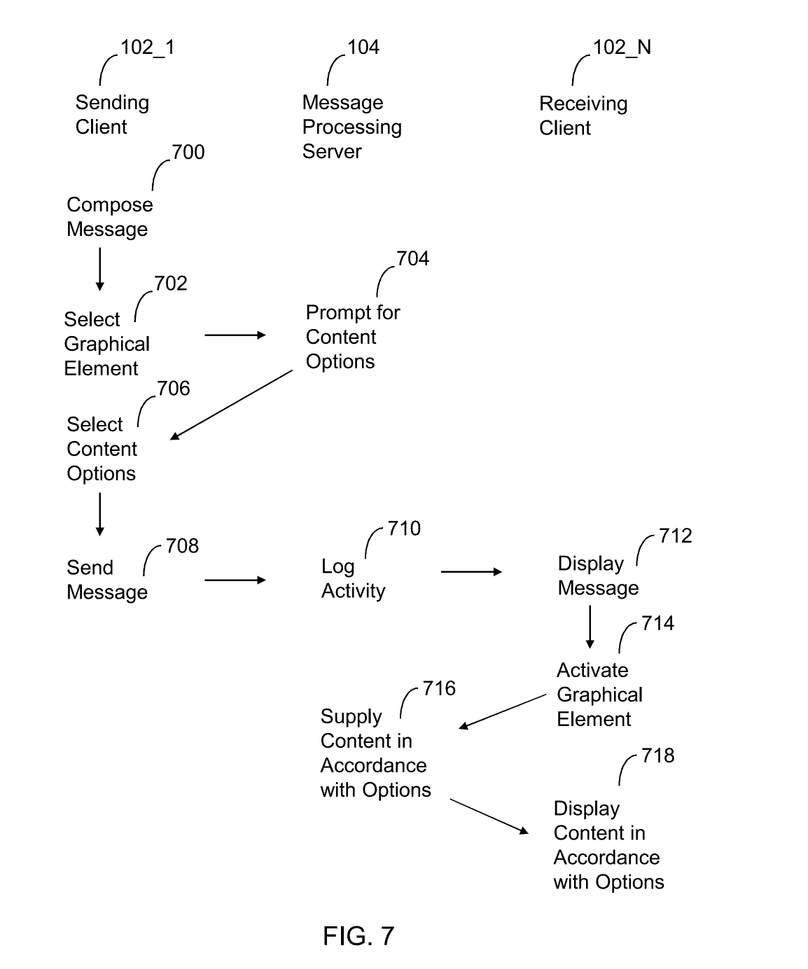

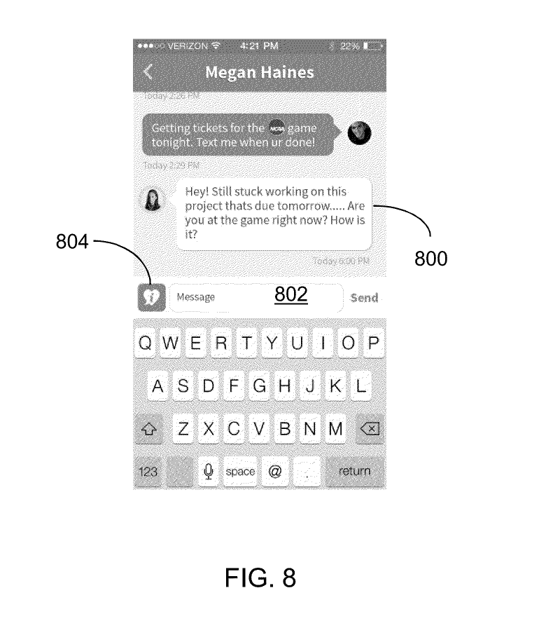

FIG. 7 illustrates processing operations associated with another embodiment of the invention. This embodiment involves a sending client 102_1, a message processing server 104 and a receiving client 102_N. A sending client composes a message 700. FIG. 8 illustrates a received message 800 and text entry block 802 to compose a responsive message.

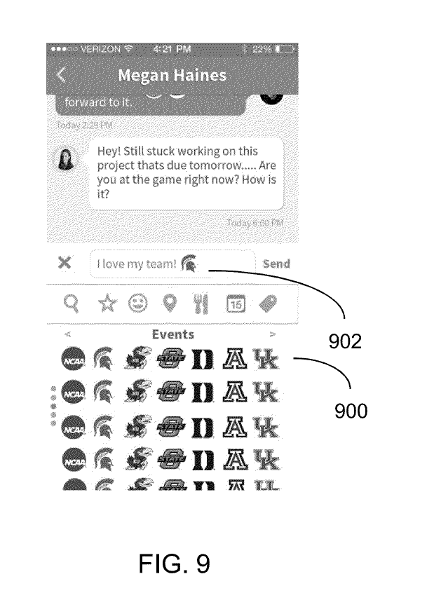

The next operation of FIG. 7 is to select a graphical element 702. For example, FIG. 8 illustrates a prompt 804 for graphical elements. Activation of the prompt results in a set of selectable graphical elements 900, as shown in FIG. 9. The graphical elements may be branded elements, as shown in FIG. 9. Alternately, the graphical elements may be emoticons. Alternately, the graphical elements may be emoticons with associated branded elements, such as shown in FIGS. 4 and 5. FIG. 9 illustrates a designated graphical element 902 embedded with a message.

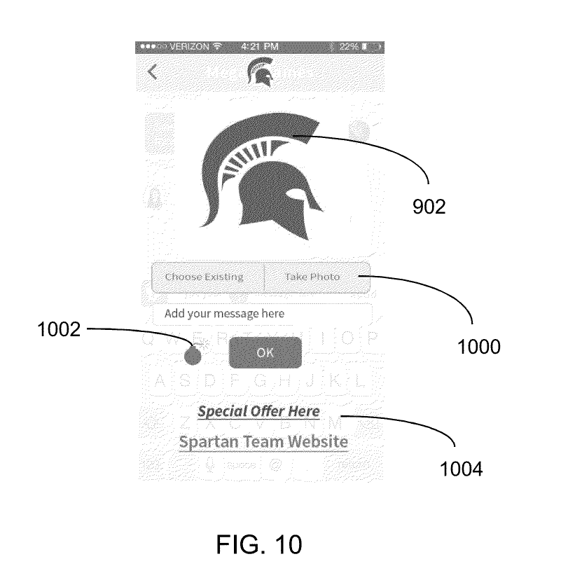

Returning to FIG. 7, after a graphical element is selected 702, the message processing server 104 prompts the message sender for content options 704. By way of example, the content options may be a photograph, a video, an endorsement and/or a content destruction parameter. FIG. 10 illustrates an interface that prompts for content options. The interface includes an option to 1000 to take a photo. A graphical element 1002 prompts a user for a content destruction time parameter. For example, the graphical element 1002 may include a number (e.g., 5) representing that the content will be destroyed in 5 seconds. Selection of the graphical element allows the number to be altered. FIG. 10 also illustrates additional content 1004 in the form of a special offer and a link to a team website.

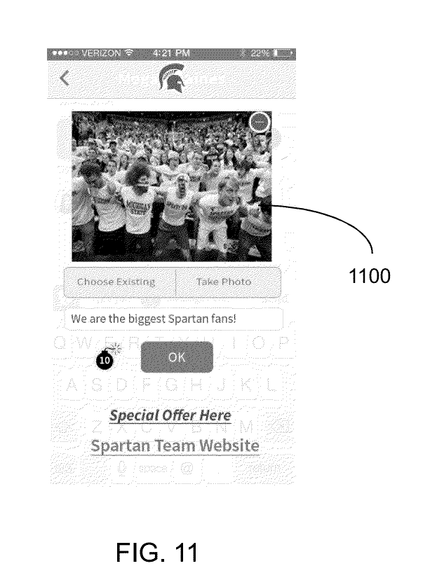

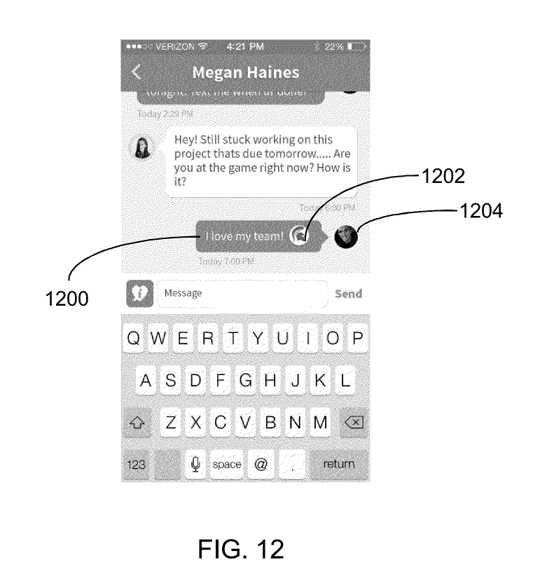

Returning to FIG. 7, the message sender selects content options 706. FIG. 11 illustrates a photograph 1100 taken for association with the graphical element. The next operation of FIG. 7 is to send the message 708. FIG. 12 illustrates the message 1200 with the designated graphical element 1202 and indicia of associated content 1204. The indicia of associated content 1204 may be an alphabetical indicator, a segment of the associated content or an indicator of transitory content (such as a bomb with a fuse, as shown).

Returning to FIG. 7, the message processing server 104 logs the activity 710 and coordinates delivery of the message. The receiving client 102_N displays the message 712. If the user at the receiving client activates the graphical element (e.g., by tapping on it) 714, the message processing server 104 supplies content, such as the photograph of FIG. 11. The content is then displayed by the receiving client 102_N in accordance with the options 718.

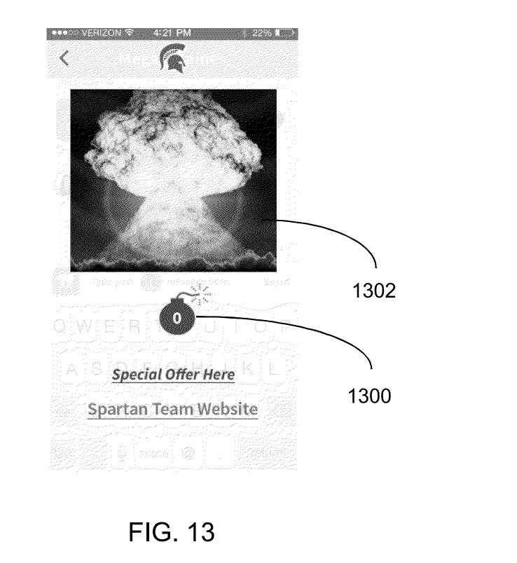

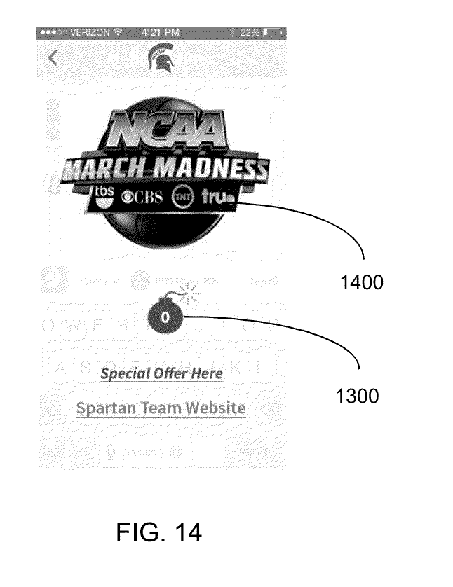

One such option may be the content destruction parameter. FIG. 13 illustrates the content destruction time 1300 at zero, which results in the elimination of the photograph. The elimination of the photograph or other content may be accompanied by a graphical component or animation, such as a bomb 1302. As shown in FIG. 14, the eliminated content may be substituted with a brand 1400 or some other type of promotional information.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method, comprising:
prompting a message sender for content options associated with a designated graphical element;
receiving a selected content option from the message sender;
associating the designated graphical element with the selected content option;
sending a message with the designated graphical element from the message sender to a message receiver; and
supplying the message receiver with the selected content in response to activation of the graphical element by the message receiver.

2. The method of claim 1 wherein the graphical element is selected from an emoticon, a branded element and an emoticon with an associated branded element.

3. The method of claim 1 wherein the content options are selected from a photograph, a video, an endorsement and a content destruction time parameter.

4. The method of claim 1 wherein the graphical element has indicia of associated content.
